(19) United States
(12) Patent Application Publication
(10) Pub. No.: US 2018/0029660 A1
(43) Pub. Date: Feb. 1, 2018

(54) Improved Construction for Scooter

(71) Applicant: Hubert Petutschnig, Brunn am Gebirge (AT)

(72) Inventor: Hubert Petutschnig, Brunn am Gebirge (AT)

(21) Appl. No.: 15/551,578

(22) PCT Filed: Feb. 15, 2016
(86) PCT No.: PCT/EP2016/053203

§ 371 Date: Aug. 16, 2017

(30) Foreign Application Priority Data
Feb. 16, 2015 (EP) 15000453.9

(51) Int. Cl. B62K 5/08; B62K 5/06; B62K 15/00; B62K 5/05

(52) U.S. Cl. CPC B62K 5/08; B62K 5/05; B62K 5/06; B62K 15/006; B62K 9/02

(57) ABSTRACT

In an aspect, a scooter is provided and includes a main body, a steering column, a front wheel unit and a rear wheel unit. The steering unit has a top and a bottom and is connected to the main body at a point intermediate the top and bottom. The front wheel unit is pivotally mounted proximate the bottom and includes first and second front wheels that are laterally spaced from one another. The front wheel unit supports the main body at least partially through the steering column. The steering column has first and second portions. The second portion extends towards the bottom from the first portion at a downward and rearward oblique angle relative to a vertical axis, so as to define a front wheel unit pivot axis. The steering unit is pivotable in a lateral-vertical plane to pivot the front wheel unit so as to steer the scooter.

### CROSS-REFERENCE TO RELATED APPLICATIONS

This application claims priority to European Patent Application No. 15000453 filed Feb. 15, 2015, the contents of which are incorporated herein in their entirety.

### FIELD OF THE DISCLOSURE

This disclosure relates to scooters and more particularly to a kick scooter with a front wheel assembly with at least two front wheels wherein the front wheel assembly is supported for rotation about an axis that is angled obliquely relative to a vertical axis.

### BACKGROUND OF THE DISCLOSURE

Scooters are well known and are used for play and sport both by children and by adults. Such scooters possess a main body including a frame, wherein a foot deck is formed directly in the frame or is fastened to the frame. The main body supports a front wheel unit and a back wheel unit. A steering column can be mounted to the main body, and may be pivotable relative to the main body in a longitudinal-vertical plane so as to permit the scooter to be folded up. The steering column has an upper end that has a handle or handlebars. In some scooters the front wheel unit has two wheels and is oriented for pivoting movement at an oblique angle relative to a vertical axis.

The front wheel unit is typically biased towards a neutral position in which the two wheels point forwardly by one or more springs or similar biasing elements. When the rider leans on the foot deck to one side or the other, or pivots the steering column to one side or the other, the foot deck leans, causing pivoting movement of the front wheel unit, which thereby steers the scooter to the left or to the right.

Such scooters, while popular, can benefit from improvement.

### SUMMARY OF THE DISCLOSURE

In an aspect, a scooter is provided and includes a main body, a steering column, a front wheel unit and a rear wheel unit. The main body has a central longitudinal axis. The steering unit has a top and a bottom and is connected to the main body at a point that is intermediate the top and the bottom. The front wheel unit includes at least a first front wheel and a second front wheel that are laterally spaced from one another. The front wheel unit is pivotally mounted proximate the bottom of the steering column. The front wheel unit supports the main body at least partially through the steering column. The steering column has a first portion and a second portion. The second portion extends towards the bottom from the first portion at a downward and rearward oblique angle relative to a vertical axis, so as to define a front wheel unit pivot axis for the front wheel unit. The rear wheel unit is mounted to the main body and is rearward of the front wheel unit. The front and rear wheel units are positioned to support the main body on a support surface. The steering unit is pivotable in a lateral-vertical plane to cause pivoting of the front wheel unit so as to steer the scooter on the support surface.

In another aspect, a scooter is provided, having a frame composed of a running board, an extension piece, and a steering column solidly joined therewith, and two wheel units lying at a distance from one another in the longitudinal direction of the scooter, supporting the frame via wheel axles. The extension piece lies in the vertical longitudinal plane of the scooter. The steering column is solidly joined to the extension piece. A handle is provided on an upper end of the steering column and a plate is provided on a lower end of the steering column, the plate being connected to the steering column at a selected angle, and a pivot axis is defined for a steerable, front wheel unit having two wheels and a support. A bearing surface of the support extends parallel to a surface of the plate, so that in the case of lateral tipping of the steering column and/or of the running board, an equivalent compulsory pivoting of the wheel unit about the pivot axis is produced with respect to the longitudinal vertical plane, wherein the plate laterally symmetrically. The selected angle between a normal line of the plate and a central axis of the steering column is such that the plate rises rearwardly counter to a forward direction of travel of the scooter, wherein the support is rotatable about the pivot axis and is parallel to the surface of the plate. A front wheel unit is installed on the steering column, particularly at the lower end of the steering column, and a change in travel direction can be brought about by means of the steering column or the handle or handlebars installed on the upper end by a lateral pivoting of the steering column via a compulsory rotation of the wheel unit that is proportional to the pivoting.

In another aspect, a scooter is provided, having a steering technique that makes possible a sporty driving, whereby, however, there will be offered the possibility of being able to reliably drive the scooter even with one hand, so that its handling will be improved. The scooter according to this aspect is a sports device or is a means of transportation that challenges the sports ability of the user, since a certain skill, in particular a greater sense of balance than in the case of a conventional scooter, is necessary. Further, the handling or operation will be facilitated by a simple one-hand steering. In addition, a better directional stability and an improved drivability than are possible with conventional scooters shall be made possible by the design of a steerable wheel unit as well as its suspension and bearing according to the invention.

In some embodiments of a scooter according to the disclosure, the frame is formed from the running board and an extension piece is installed thereon and a steering column, the steering column has a front wheel unit thereon that is suitable for directional steering. It is provided that a defined deflection of the front wheel unit to the left or right can be produced merely by the sidewise tipping of the sports device, i.e., tipping the running board and/or the steering column to the left or to the right. The wheel unit—which includes the moveable support with two laterally projecting axle journals and the front wheels mounted thereon—will be pivoted about its axis of rotation due to the pressure exerted upon a tipping of the frame caused by a laterally directed steering movement of the steering column. In this way, the wheel unit will be forcibly deflected from its neutral position directed straight ahead to a direction that corresponds to the direction of the introduced pressure or of the tipping movement.

For this purpose, the steering column possesses an obliquely standing support plate on its lower end pointing toward the bottom. There is provided at least one movable wheel unit for directional steering, this unit being mounted rotatably to the oblique-standing plate in the region of the defined central axis of the steering column.

It is thus provided that the front wheel support is pivotable about the central axis of the steering column in the plane defined by the obliquely standing plate, which supports the two wheel axles projecting at an angle, or that the respective wheel axle is mounted on the latter so that in can rotate about the central axis in the plane running perpendicular, and/or that in the case of a scooter aligned for travel straight ahead, the wheel axles are essentially perpendicular to the central plane of the scooter or, in another preferred embodiment, not only projecting at an angle upward, but also at an angle downward counter to the direction of travel. Therefore a smooth, sensitive, and precisely responsive control of the scooter will be achieved.

The back wheel unit according to some embodiments of the invention is provided in a conventional construction, comparable to a back wheel of a scooter construction of the prior art, and is mounted on a rigid axle or on a movable axle with pressurized balancing force.

The tipping of the running board or of the frame about the longitudinal axis of the scooter or of the running board by means of the steering column is produced in such a way that a tipping movement of the frame about the longitudinal axis of the scooter is brought about on the running board forming a part of the frame by laterally pivoting the steering column or correspondingly pressurizing and tipping the running board, whereby, via the plate provided at an angle on the lower end of the steering column, with the rotatable wheel unit parallel to this plate, a movement of this wheel unit will be achieved in the form of a compulsory pivoting to the left or right. A tipping to the right steers a curve to the right and vice versa.

For improvement in travel safety, it is of advantage, if an actuating mechanism for a hand braking device is provided on the handle provided at the upper end of the handlebars.

The driving characteristics of the scooter can be influenced in a stabilizing manner by providing that the wheel axle is located at the height of the running board and/or that the wheel axles of wheel units lying in front of and behind the running board in the direction of travel lie at the same level and/or above the level of the running board. Steering is smooth and direct when the two wheel axles of the front wheel unit project to the back, whereby the two front wheels obtain an opening angle according to FIG. 3 on their front side.

The position of the oblique plate installed on the lower end of the steering column, as viewed from the side (FIG. 1, lateral elevation, steerable wheel unit on the left side), is directed backward and outward (backward indicates pointing opposite to the direction of travel), and thus forms an angle between the central axis of the steering column and the normal line of the plate in the range between 20 degrees and 70 degrees, preferably between 25 degrees and 65 degrees, in particular between 30 degrees and 60 degrees and more particularly about 45 degrees. This angle range produces a good operability and handling of the scooter, in particular in the case of traveling around curves.

In order to avoid over-control or driving around curves with too small a radius in the case of too great a lateral pivoting of the steering column or in the case of exerting too high a tipping pressure on the running board surface, it can be provided that the pivoting angle of the wheel unit and/or the support and/or relative to a vertical axis or the axis of the steering column is limited by a limiting unit, such as, e.g., by a stop.

A simple operation of the scooter results when, on their upper end remote from the running board, the handlebars support a crosswise running handle as a holding piece for one-hand operation.

In the case of a scooter aligned for travel straight ahead, the wheel axles project perpendicular in the longitudinal direction (along the x-axis) without correction—and project backward with correction—relative to the longitudinal central plane of the scooter, but in the vertical plane (along the y-axis) point upward at an angle, so that, as a consequence, the two wheels of the steerable wheel unit are no longer disposed side-parallel to one another, but, when observed from the front, comparable to the capital letter A, are close together in the upper region and are further apart in the lower region. In this way, on the one hand, a reliable as well as a sensitive and precisely responsive control of the scooter will be achieved, and, on the other hand, the tipping of the wheel unit will be avoided in the case of greater curve forces, since in travel around curves, forces acting on the outer wheel during travel around a curve, act just at an angle against the traveled surface, whereby a wheel suspension/wheel axle is found closer to the scooter frame than the lower supporting point of a wheel (FIG. 2) pointing to the ground.

The steering properties of the scooter can be constructively influenced by pointing the wheel axles of a wheel unit backward (along the x-axis) counter to the direction of travel in a marginal angle region, so that the wheels found on the axles provide a defined opening angle in the direction of travel. In this case, the tops of the front wheels are further apart than the back wheels.

### BRIEF DESCRIPTION OF THE DRAWINGS

The invention will be explained in detail in the following on the basis of the drawings, by way of example.

FIG. 1 shows a side elevation view of a scooter;

FIG. 2 shows a magnified front elevation view of the front wheel unit of the scooter shown in FIG. 1;

FIG. 3 shows a top plan view of the scooter shown in FIG. 1;

FIG. 4 is a side view showing part of the scooter shown in FIG. 1, in a storage position;

FIG. 5 is a magnified side view of a front wheel unit of the scooter shown in FIG. 1;

FIG. 6 is a magnified side view similar to FIG. 5 but showing a first portion of a steering unit of the scooter shown in FIG. 1 in an angled position relative to a vertical axis.

### DETAILED DESCRIPTION

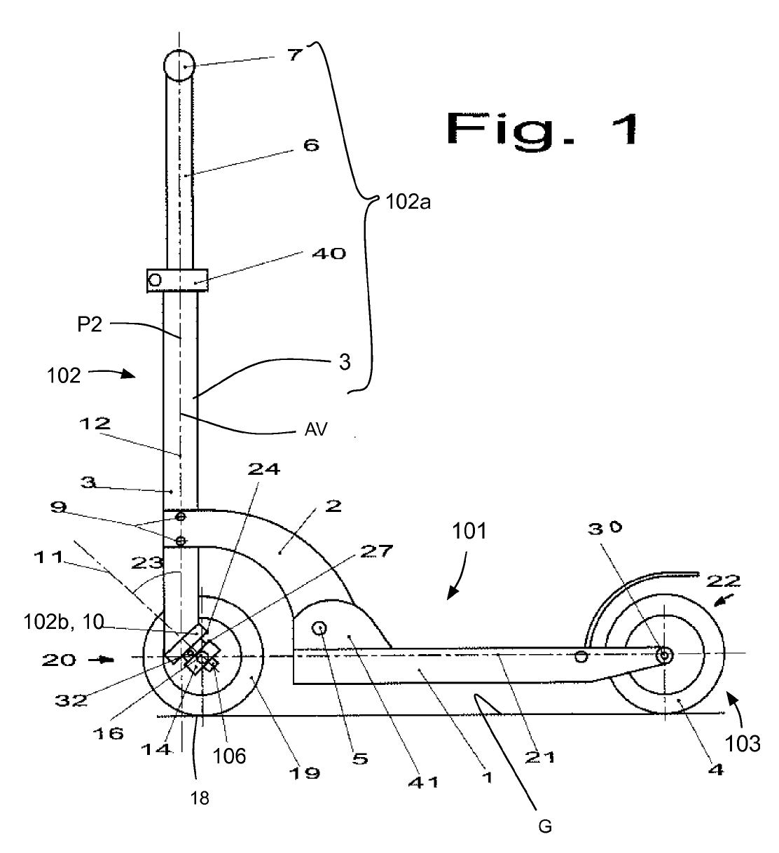

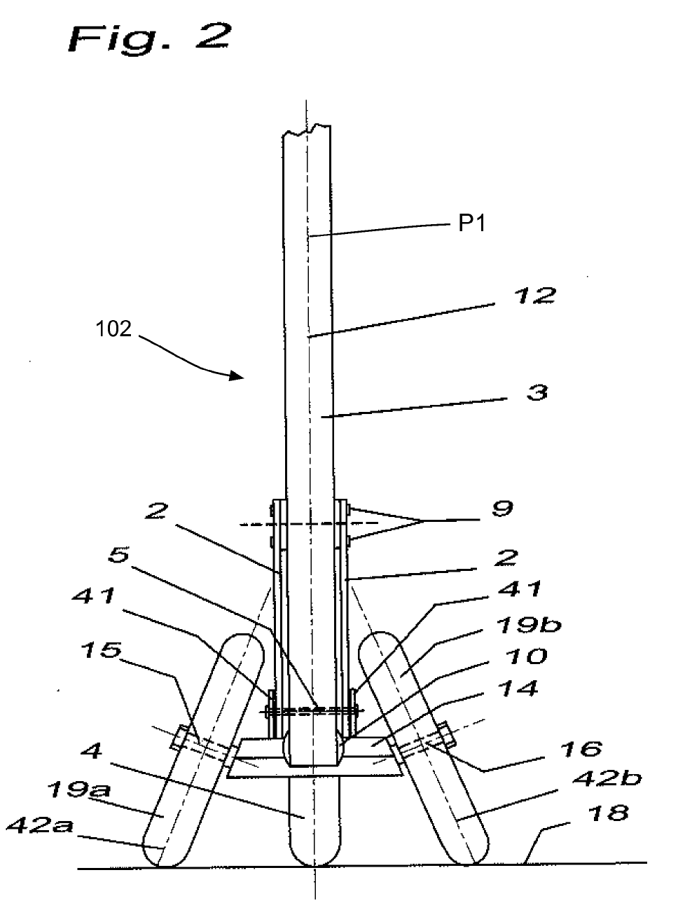

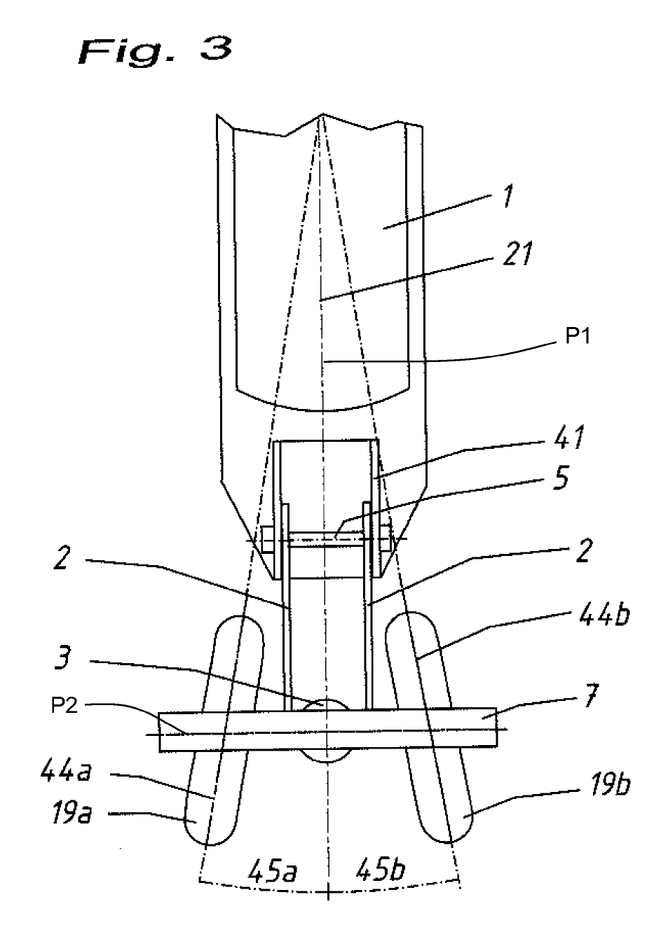

A scooter 10 is shown basically aligned for travel straight ahead in the drawings. The scooter 10 may constructed symmetrically relative to its longitudinal vertical plane shown at P1 in FIGS. 2 and 3. The scooter 10 also has a vertical lateral plane shown at P2 in FIGS. 1 and 3.

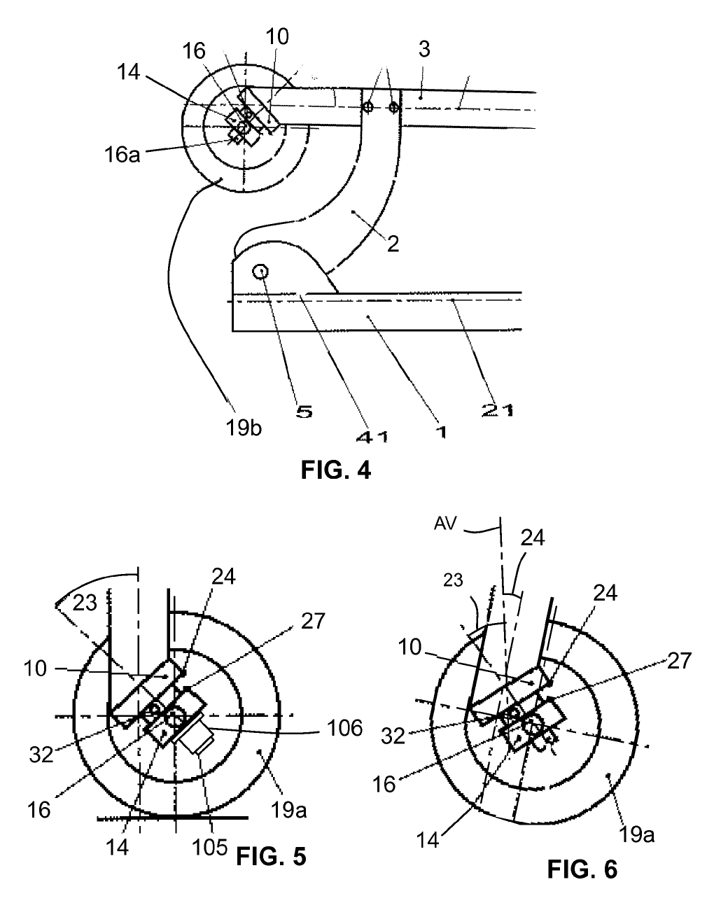

FIG. 1 shows the scooter 10 with a main body 101 which has the longitudinal vertical plane P1 and includes a running board 1 and an extension piece 2 that may be pivotably connected to the running board 1 or alternatively may be fixedly connected to the running board 1. The main body 101 may thus be considered to include the extension piece 2 and a remainder of the main body 101 to which the extension piece may be pivotably connected. In the case of pivotable connection, it is possible to connect the running board 1 and the extension piece 2 in a pivotable manner with a pivot bearing 5 or via a pivot bolt, in order to be able to fold up the scooter 10. The pivoting movement of the extension piece 2 permits movement of the scooter 10 between a use position (FIG. 1) and a storage position (FIG. 4).

In this embodiment, the extension piece 2 projects in the direction of travel forwardly and upward from the running board 1. On the free front end of this extension piece 2 is installed a steering column 3. The steering column 3, which is solidly joined to the extension piece 2, for example, by screwing or welding, whereby the steering column 3 is inclined counter to the direction of travel, such that the central axis 12 of the steering column 3 projecting vertically from the scooter encloses an angle between 70 degrees and 90 degrees, preferably 75 degrees and 85 degrees, particularly 78 degrees to 82 degrees, with the horizontal longitudinal axis 21 of the scooter. The angle of the first portion 102a of the steering unit 102 (e.g. of the steering column 3) relative to the vertical axis AV is shown at 23a in FIG. 6. Based on the aforementioned, the angle 23a between first portion 102a of the steering unit 102 and the vertical axis AV (rearward of the vertical axis AV) of between about 20 degrees and about 0 degrees, or preferably between about 15 degrees and about 5 degrees or more preferably between about 12 degrees and about 8 degrees. The steering column 3 has a telescoping inner tube 6 which can be tightened in a selected position by means of a locking clamp 40, thereby providing adjustability to the height of a handlebar 7. The steering column 3, the inner tube 6, the locking clamp 40 and the handlebar 7 all are included in a steering unit 102 and together form a first portion 102a of the steering unit 102.

The steering unit 102 has a top and a bottom. The handlebar 7 is provided at the top of the steering unit 102. As can be seen by the connection to the extension piece 2, the steering unit 102 is connected to the main body 102 at a point that is intermediate the top and the bottom.

On a lower end of the steering column 3 there is an obliquely standing plate 10 which is included in a second portion 102b of the steering unit 102. The normal axis 11 to the plate 10 encloses an angle 23 with the central axis 12 of the steering column 3. The installed position of the oblique plate 10 on the lower end of the steering column 3 thus runs, when seen from the side, counter to the direction of travel, directed backward and upward, and thus forms an angle between its normal line 11 and the central axis 12 of the steering column 3 between 20 degrees and 70 degrees, preferably between 25 degrees and 65 degrees, in particular between 30 degrees and 60 degrees. This angle range produces a good operability and handling of the scooter, in particular in the case of traveling around curves. The angle between the central axis 12 and the normal line 11 relative to the plate 10 defines precisely the curve radius proportional to the lateral tipping angle of the steering column. The angle 23 may be said to be the angle between the second portion 102b and the first portion 102a of the steering unit 102. The second portion 102b extends towards the bottom of the steering unit from the first portion 102a at a downward and rearward oblique angle relative to a vertical axis AV, so as to define a front wheel unit pivot axis 11 for the front wheel unit 20.

The front wheel unit 20 includes the front wheel support 14 and first and second front wheels 19a and 19b which are laterally spaced from one another. The front wheel support 14 is mounted on the plate 10 and is freely rotatable within a defined range. The front wheel support supports first and second wheel axles 15 and 16, on which the first and second front wheels 19a and 19b rotate. Thus the front wheels 19a and 19b are rotatably mounted to the front wheel support 14.

In the rear of the running board 1 is mounted a rear wheel unit 103 that may include conventional wheel 4 with a rigidly mounted wheel axle 30. Thus the rear wheel unit 102 is mounted to the main body 101 rearward of the front wheel unit 20.

The front and rear wheel units 20, 103 are positioned to support the main body on a support surface G (e.g. the ground). It will be noted that the front wheel unit 20 supports the main body 101 at least partially through the steering member 102. In the embodiment shown, the front wheel unit 20 supports the main body 101 entirely through the steering member 102. However, in alternative embodiments, the front wheel unit 20 may be connected to both the steering member 102 and may independently also be connected directly to the main body 101 so that it supports the main body 101 partially through the steering member 102 and partially directly.

The steering of the scooter 10 is essentially based on the fact that the back and the front wheel units 20, 103 are disposed, in particular, centrally and flush along the longitudinal vertical plane P1 (which is a plane of symmetry of the scooter 10), and that the plate 10 is also tipped together with them from the initial neutral position into a direction corresponding to a lateral tipping of the steering column 3 relative to the longitudinal axis 21. For example, if the steering column 3 is tipped to the right relative to the longitudinal axis 21, then the freely rotatable front wheel unit 20 also follows the direction of the deflected plate 10 to the right, forcibly against the constantly uniform position of the contact area against which the front wheel unit 20 rests with the force of the weight acting on the scooter 10 from above.

The amount of the proportional deflection of the front wheel unit 20 is greater, the smaller the angle 23 is selected, depending on the system. The deflection of the front wheel unit 20 as a consequence of a tipping of the steering column 3 or of the running board surface 1 is then sufficiently produced if, as is shown in FIG. 2, the distance A between the two wheels 19a and 19b is so great that the necessary force can be built up for the deflection or rotation of the front wheel unit 20. This means that with an enlargement of the angle 23, the steering force increases and consequently, the distance A between the two wheels 19a and 19b can be selected to be correspondingly greater.

The forcibly controlled pivoting of the support 14 opposite the fixed plate 10 provides that a bearing device 32 of any structural kind (such as a thrust bearing), particularly acting in the axial direction, is found between the two limiting surfaces 24 and 27.

The front wheel unit 20 is pivotally mounted proximate the bottom of the steering unit 102. A front wheel support pivot shaft 105 extends from the lower surface 24 of the plate 10 and pivotally supports the front wheel support 14 thereon for pivoting movement about the front wheel unit pivot axis, which is axis 11. In the embodiment shown the shaft 105 forms part of the steering unit 102, however, it is alternatively possible for the steering unit 102 to include an aperture in the plate 10 for receiving a shaft that is part of the front wheel unit 20. The connection of this bearing 32 that takes up predominantly axial forces is assured by at least one fixing element 106 of any structural kind, which is shown more clearly in FIG. 5. This fixing element 106 can be formed e.g. from one or more screws or a nut or any other fastening elements. By increasing the pressure between the bearing surfaces 24, 27 using fastener 106, such as e.g., by tightening a nut or a screw, the sensitivity of the steering thus can be changed by increasing or decreasing the friction forces between the bearing surfaces 24 and 27 and the bearing 32 by means of the fixing element 16, so that the directional control of the scooter 10 can be adjusted more or less smoothly within the permissible limits by any adjustment of the fastening element 16.

In the figures, the planes P1 and P2 are shown edge on only so as not to clutter the figures. However, this is sufficient in order to impart the orientation of the planes P1 and P2.

While the description contained herein constitutes a plurality of embodiments of the present invention, it will be appreciated that the present invention is susceptible to further modification and change without departing from the fair meaning of the accompanying claims.

1. A scooter, comprising:
a main body having a central longitudinal axis;
a steering unit that has a top and a bottom and is connected to the main body at a point that is intermediate the top and the bottom;
a front wheel unit that includes at least a first front wheel and a second front wheel that are laterally spaced from one another, wherein the front wheel unit is pivotally mounted proximate the bottom of the steering unit, wherein the front wheel unit supports the main body at least partially through the steering unit;
wherein the steering unit has a first portion and a second portion, and wherein the second portion extends towards the bottom from the first portion at a downward and rearward oblique angle relative to the first portion, so as to define a front wheel unit pivot axis for the front wheel unit; and
a rear wheel unit that is mounted to the main body and that is rearward of the front wheel unit,
wherein the front and rear wheel units are positioned to support the main body on a support surface,
wherein the steering unit is pivotable in a lateral-vertical plane to cause pivoting of the front wheel unit so as to steer the scooter on the support surface.

2. A scooter as claimed in claim 1, wherein the front wheel unit includes a front wheel support that rotatably supports the first and second front wheels, wherein the front wheel support has an upper bearing surface, and wherein the steering unit has a lower bearing surface, and wherein a front wheel unit bearing member is positioned between the upper and lower bearing surfaces to support pivoting of the front wheel support relative to the front wheel unit pivot axis against axial forces.

3. A scooter as claimed in claim 1, wherein the steering unit has a front wheel support pivot shaft that extends from the lower bearing surface, wherein the front wheel support is rotatably supported on the front wheel support pivot shaft.

4. A scooter as claimed in claim 1, wherein the steering unit is pivotable relative to the main body.

5. A scooter as claimed in claim 4, wherein the steering unit is fixedly connected to an extension piece from the main body, and wherein the extension piece extends downwards to pivotally connect to a remainder of the main body.

6. A scooter as claimed in claim 1, wherein the rear wheel unit includes a single wheel.

7. A scooter as claimed in claim 1, wherein a limit surface limits a range of pivoting movement that is available to the front wheel unit relative to the steering unit.

8. A scooter as claimed in claim 1, wherein the front wheel unit pivot axis is oriented obliquely relative to the first portion of the steering unit by an angle that is between about 20 degrees and about 70 degrees.

9. A scooter as claimed in claim 1, wherein the front wheel unit pivot axis is oriented obliquely relative to the first portion of the steering unit by an angle that is between about 30 degrees and about 60 degrees.

10. A scooter as claimed in claim 1, wherein the front wheel unit supports the main body solely through the steering unit.

11. A scooter as claimed in claim 8, wherein the first portion of the steering unit extends upwards from the second portion towards the top at an angle between about 20 degrees and 0 degrees rearward of a vertical axis.

12. A scooter as claimed in claim 8, wherein the first portion of the steering unit extends upwards from the second portion towards the top at an angle between about 15 degrees and about 5 degrees rearward of a vertical axis.

13. A scooter as claimed in claim 8, wherein the first portion of the steering unit extends upwards from the second portion towards the top at an angle between about 12 degrees and about 8 degrees rearward of a vertical axis.

14. A scooter as claimed in claim 1, wherein the first and second front wheels extend slanted at an angle to each other of between about 10 degrees and about 80 degrees, and respective regions of the wheels that are distal to the support surface are closer to each other than regions of the wheels that are proximate to the support surface.

15. A scooter as claimed in claim 1, wherein the first and second front wheels extend slanted at an angle to each other of between about 30 degrees and about 60 degrees, and respective regions of the wheels that are distal to the support surface are closer to each other than regions of the wheels that are proximate to the support surface.

16. A scooter as claimed in claim 1, wherein the first and second front wheels extend slanted at an angle to each other of about 45 degrees in a vertical lateral plane, and respective regions of the first and second front wheels that are distal to the support surface are laterally closer to each other than regions of the first and second front wheels that are proximate to the support surface.

17. A scooter as claimed in claim 1, wherein the first and second front wheels extend slanted at a non-zero angle to each other such that rear regions of the first and second front wheels are closer to each other than are front regions of the first and second front wheels.

18. A scooter as claimed in claim 1, wherein the steering unit includes a steering column that extends generally straight.

19. A scooter having a frame composed of a running board (1), an extension piece (2), and a steering column (3) solidly joined therewith, and two wheel units (20, 22) lying at a distance from one another in the longitudinal direction of the scooter, supporting the frame (1, 2, 3) via wheel axles (15, 16) and (30), wherein the extension piece (2) lies in the vertical longitudinal plane of the scooter, wherein the steering column (3) is solidly joined to the extension piece (2), and wherein, a handle (7) is provided on an upper end of the steering column (3, 6) and a plate (10) is provided on a lower end of the steering column, the plate (10) being connected to the steering column (3) at a selected angle, and a pivot axis (11) is defined for a steerable, front wheel unit (20) having two wheels (19a, 19b) and a support (14), and wherein a bearing surface (27) of the support (14) extends parallel to a surface (24) of the plate (10), so that in the case of lateral tipping of the steering column (3) and/or of the running board (1), an equivalent compulsory pivoting of the wheel unit (20) about the pivot axis (11) is produced with respect to the longitudinal vertical plane, wherein the plate (10) laterally symmetrically, and wherein the selected angle between a normal line of the plate (10) and a central axis (12) of the steering column (3) is such that the plate (10) rises rearwardly counter to a forward direction of travel of the scooter, wherein the support (14) is rotatable about the pivot axis and is parallel to the surface (24) of the plate (10).
